(19) United States
(12) Patent Application Publication
(10) Pub. No.: US 2025/0284995 A1
(43) Pub. Date: Sep. 11, 2025

(54) QUANTUM COMPUTING SYSTEM AND INTER-DEVICE SYNCHRONIZATION CONTROL METHOD FOR QUANTUM COMPUTING

(71) Applicant: Hitachi, Ltd., Tokyo (JP)

(72) Inventor: Takanobu TSUNODA, Tokyo (JP)

(21) Appl. No.: 18/897,351

(22) Filed: Sep. 26, 2024

(30) Foreign Application Priority Data
Oct. 2, 2023 (JP) 2023-171298

(51) Int. Cl. G06N 10/40

(52) U.S. Cl. CPC G06N 10/40

(57) ABSTRACT

A quantum computing system includes a quantum device configured to execute a quantum operation; instrumentation devices configured to transmit a control signal for executing the quantum operation; and a synchronization trigger distribution device configured to transmit a second trigger signal for instructing transmission of the control signal to at least one of the instrumentation devices based on a first trigger signal indicating a timing. The synchronization trigger distribution device includes a control sequence table for specifying a predetermined instrumentation device, to which the second trigger signal is to be output, based on the first trigger signal, and a delay time table for specifying a delay time corresponding to each of the instrumentation devices. The synchronization trigger distribution device outputs the second trigger signal to the instrumentation device specified based on the control sequence table, at a timing based on the delay time specified based on the delay time table.

### CROSS-REFERENCE TO RELATED APPLICATION

The present application claims priority from Japanese application JP2023-171298, filed on Oct. 2, 2023, the content of which is hereby incorporated by reference into this application.

### BACKGROUND OF THE INVENTION

### 1. Field of the Invention

The present invention relates to a gate type quantum computer system, and more particularly, to an inter-device synchronization control method for constructing a system by a plurality of instrumentation devices (including a form of a semiconductor chip), which operate in cooperation with each other with high timing accuracy, by using an operation for an electron spin of a quantum computing device in which a plurality of single electron spin quantum dots are arranged and generating a control signal necessary for reading an electron spin state.

### 2. Description of Related Art

It is seen as a sure thing that the performance improvement by the miniaturization of the semiconductor element which has supported the progress of the computer for more than a half century will reach its limit in the near future considering the comparison between the process rules and the interatomic distance of silicon. Quantum computers are an attempt to break the limit by new computing principles and devices, and quantum computing devices and computing methods using superconducting circuits, ion traps, photons, silicon quantum dots, and the like have been proposed. In addition, as a first step to a future concept of executing a large-scale practical application in a general-purpose quantum computer system having error tolerance, the principle proof and algorithm search for a system referred to as a noisy intermediate-scale quantum device (NISQ) are in progress on the premise of a concept at the present time that the number of quantum bits is as small as about 100 and error correction cannot be performed.

In order to implement a quantum computer system to which a quantum computing device using a quantum effect exhibited at an extremely low temperature as a computing principle, such as a single electron spin in a silicon quantum dot, a dilution refrigerator is generally selected as an accommodating device. In this case, a configuration of an experimental device is often adopted in which the quantum computing device is fixed in thermal contact with a mixing chamber in which the temperature is lowest in the dilution refrigerator, a signal necessary for operation control of the quantum computing device is applied from a signal generator provided outside the dilution refrigerator, and a computing result (quantum dot state) is read by a measuring machine provided similarly outside the dilution refrigerator.

PTL 2 discloses a system including at least two sets of superconducting logic devices, a cooling device adapted to cool the logic devices to a first operating temperature, and an interconnection coupling the superconducting logic devices.

PTL 3 discloses a quantum bit array including: a semiconductor layer; an insulating layer provided on the semiconductor layer; and a plurality of first gate electrodes provided on the insulating layer and configured to trap electrons in a predetermined spin state in the semiconductor layer by applying a voltage. The quantum bit array has a means to flow, in an extending direction of the first gate electrode, a current for forming a magnetic field acting on the electrons to at least one of the first gate electrodes when changing the spin state of the electrons.

### CITATION LIST

### Patent Literature

PTL 1: JP2013-090358A
PTL 2: JP2021-523572A
PTL 3: JP2022-130893A

### SUMMARY OF THE INVENTION

For example, in order to arrange the quantum bit array disclosed in PTL 3 at the coolest portion (extremely low temperature environment) of a dilution refrigerator and control quantum computing at high speed, it is necessary to supply a synchronization signal with high accuracy. Since the space of a region maintained in the extremely low temperature environment is restricted, it is preferable to supply the synchronization signal from the outside of the extremely low temperature environment. However, it is difficult to reduce the wiring length in providing the synchronization signal from the outside, and it is difficult to improve the synchronization accuracy.

PTL 1 discloses a technique regarding system voltage detection and phase synchronization control in a series multiplex inverter device that operates in cooperation with a system. According to the technique, a phase synchronization signal is corrected (advanced) on the master control device side by a time required for generation thereof, thereby improving synchronization accuracy for a system of a plurality of slave control devices controlled by the signal. When a synchronization target serving as a reference of a device operation has a repetitive waveform of a system voltage or the like and a plurality of slave control devices perform the same operation, it can be expected that operations of all the slave control devices are efficiently synchronized with the system by using the technique.

A quantum computer having a quantum computing device as a core is an analog computer in which analog information is actually assigned to quantum dots. In order to obtain a desired fidelity of a quantum operation for determining final computing accuracy of a quantum computer, it is not sufficient to introduce an instrumentation device such as a bias voltage generation device or a radio-frequency generation device having necessary and sufficient accuracy and characteristics, or a minute voltage/current amplifying device used for reading a state of a quantum dot such as an electron spin, and to connect the instrumentation device to a quantum computing device. It is required to control an operation timing of each instrumentation device in accordance with a control sequence of a quantum operation desired to be executed, and to match (synchronize) relative operation timings between the devices with high time accuracy (for example, 10 nanoseconds).

Normally, the vendor of the introduced instrumentation device is not single, and in addition, a response delay time of the instrumentation device, that is, a time from when a device controlling the instrumentation device issues a predetermined operation request to when the requested operation is actually started on the instrumentation device side (including a propagation delay of the medium transmitting the operation request and a delay due to a protocol) is different for each instrumentation device. This characteristic is common even when a module measurement system of PXI (trademark) or the like is introduced, and it is needless to say that control synchronization between modules in consideration of a response delay time is necessary.

Therefore, an object of the invention is to provide an accurate synchronization signal for controlling quantum computing at high speed.

A preferred aspect of the invention is a quantum computing system including: a quantum device configured to execute a quantum operation; a plurality of instrumentation devices configured to transmit a control signal for executing the quantum operation to the quantum device; and a synchronization trigger distribution device configured to transmit a second trigger signal for instructing transmission of the control signal to at least one of the plurality of instrumentation devices based on a first trigger signal indicating a timing. The synchronization trigger distribution device includes a control sequence table for specifying a predetermined instrumentation device, to which the second trigger signal is to be output, among the plurality of instrumentation devices based on the first trigger signal, and a delay time table for specifying a delay time corresponding to each of the plurality of instrumentation devices. The synchronization trigger distribution device outputs the second trigger signal to the instrumentation device specified based on the control sequence table, at a timing based on the delay time specified based on the delay time table.

Another preferred aspect of the invention is an inter-device synchronization control method for quantum computing, the method using a quantum device configured to execute a quantum operation, a plurality of instrumentation devices configured to transmit a control signal for executing the quantum operation to the quantum device, and a synchronization trigger distribution device configured to transmit a second trigger signal for instructing transmission of the control signal to at least one of the plurality of instrumentation devices based on a first trigger signal indicating a timing. The method includes using the synchronization trigger distribution device to execute: a first step of specifying a predetermined instrumentation device, to which the second trigger signal is to be input, among the plurality of instrumentation devices based on the first trigger signal; a second step of specifying a delay time corresponding to each of the plurality of instrumentation devices; and a third step of outputting the second trigger signal to the instrumentation device specified based on the first step, at a timing based on the delay time specified based on the second step.

It is possible to supply an accurate synchronization signal for controlling the quantum computing at high speed.

### BRIEF DESCRIPTION OF THE DRAWINGS

FIG. 1 is a block diagram illustrating a configuration of a quantum computing system 1 according to a first embodiment;

FIG. 2 is a block diagram illustrating a configuration of a synchronization trigger distribution device 200;

FIG. 3 is a table illustrating an example of settings in a control sequence table 230;

FIG. 4 is a table illustrating an example of settings in a response delay time table 240;

FIG. 5 is a table illustrating an example of definition of a command format of a master trigger signal 303;

FIG. 6 is a timing chart of a control sequence of quantum operations in the quantum computing system 1;

FIG. 7 is a detailed timing chart relating to sequence switching in the synchronization trigger distribution device 200;

FIG. 8 is a block diagram illustrating a configuration of a quantum computing system 1A according to a second embodiment;

FIG. 9 is a block diagram illustrating a configuration of a synchronization trigger distribution device 200A;

FIG. 10 is a table illustrating an example of settings in a control sequence table 230A;

FIG. 11 is a table illustrating an example of settings in a response delay time table 240A;

FIG. 12 is a timing chart of a control sequence of quantum operations in the quantum computing system 1A;

FIG. 13 is a block diagram illustrating a configuration of a quantum computing system 1B according to a third embodiment; a block diagram illustrating a configuration of a quantum computing system 1B according to a third embodiment (OMITTED)

FIG. 14 is a block diagram illustrating a configuration of a synchronization trigger distribution device 200B;

FIG. 15 is a table illustrating an example of settings in a control sequence table 230B;

FIG. 16 is a timing chart of a control sequence of quantum operations in the quantum computing system 1B; and

FIG. 17 is a conceptual diagram in which a quantum computing system according to an embodiment is mounted in a dilution refrigerator.

### DESCRIPTION OF EMBODIMENTS

Hereinafter, embodiments will be described with reference to the accompanying drawings. In the accompanying drawings, components functionally the same may be indicated by the same numbers or corresponding numbers. Although the accompanying drawings illustrate embodiments and examples in accordance with the principle of the present disclosure, the accompanying drawings are for understanding the present disclosure and are not intended to interpret the present disclosure in a limited manner. The description of the present specification is merely a typical example, and does not limit the scope of claims or application examples of the present disclosure in any sense.

In the embodiments, description is made in detail sufficiently in order for a person skilled in the art to implement the present disclosure, and other implementation and forms are also possible, and it is necessary to understand that a change in configuration and structure and replacement of various components are possible without departing from the scope and spirit of the technical idea of the present disclosure. Therefore, the following description should not be interpreted as being limited thereto.

In the configurations of the embodiments described below, the same portions or portions having the same functions are denoted by the same reference sign in different drawings, and redundant description thereof may be omitted.

When there are a plurality of components having the same or similar functions, the description may be made by assigning the same reference signs thereof with different subscripts. When it is not necessary to distinguish the plurality of components from each other, the description may be made by omitting the subscripts.

The notations “first”, “second”, “third”, and the like in the present specification and the like are provided to identify the components, and do not necessarily limit the number, the order, or the content thereof. A number for identifying a component is used for each context, and the number used in one context does not necessarily indicate the same configuration in another context. In addition, this does not prevent a component identified by a certain number from also having a function of a component identified by another number.

In order to facilitate understanding of the invention, the position, size, shape, range, and the like of each configuration shown in the drawings or the like may not represent the actual position, size, shape, range, or the like. Therefore, the invention is not necessarily limited to the positions, sizes, shapes, ranges, or the like disclosed in the drawings.

Publications, patents, and patent applications cited in the present specification constitute a part of the description of the present specification.

In the present specification, a component represented in a single form includes a plurality of forms unless otherwise clearly described in the context.

In the embodiment, in relation to a quantum computer system implemented by combining a plurality of instrumentation devices having different response delay times, a configuration will be described which provides an inter-device synchronization control method necessary for implementing a control sequence of a desired quantum operation and achieving a fidelity requirement, a synchronization trigger distribution device which generates a trigger signal specific to the instrumentation device for which the response delay time is corrected according to a preset control sequence, and a quantum computer system including the synchronization trigger distribution device.

A quantum computing system according to an embodiment includes: a plurality of instrumentation devices configured to execute at least a part of quantum operations in a control sequence of the quantum operations; and a synchronization trigger distribution device configured to output a synchronization signal to the plurality of instrumentation devices. The synchronization trigger distribution device receives a trigger signal from a first instrumentation device. Based on a control sequence table for specifying whether it is a timing at which the synchronization signal is to be output to the plurality of instrumentation devices (including the first instrumentation device), and a delay time table for defining a processing delay time of the plurality of instrumentation devices starting from the synchronization signal, the synchronization trigger distribution device outputs a corrected synchronization signal whose timing is corrected so as to correct a specific processing delay time to the instrumentation device that is at a timing at which the synchronization signal is to be output.

Further, a modification of the synchronization trigger distribution device includes an execution time control unit that internally generates a signal in replace of the trigger signal received from the first instrumentation device and that can implement an autonomous control sequence independent of the trigger signal.

According to the inter-device synchronization control method, the instrumentation devices, and the synchronization trigger distribution device according to the embodiment, a highly practical quantum computing system is implemented in which operations of a plurality of instrumentation devices having different processing delay times are synchronized with high timing accuracy, and a control sequence of a desired quantum operation can be autonomously executed.

### First Embodiment

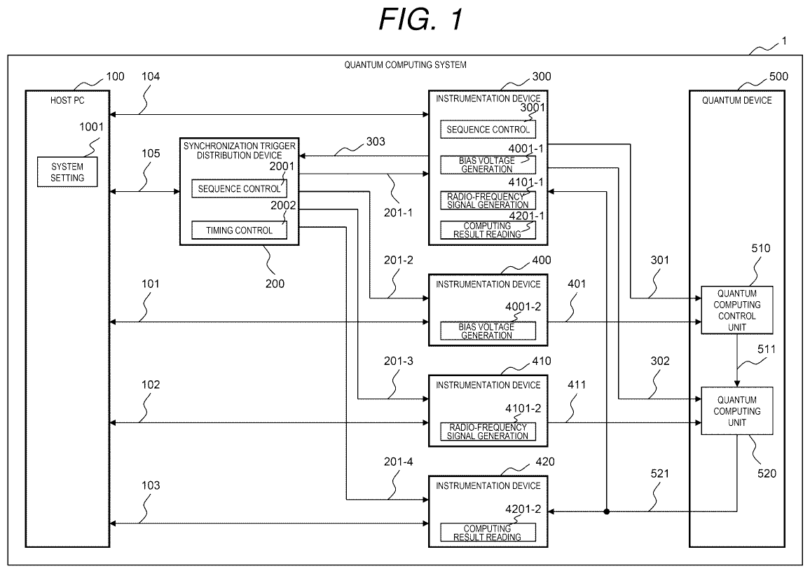

FIG. 1 illustrates a configuration of a quantum computing system 1 according to a first embodiment of the invention. The embodiment is a system obtained by combining a host PC 100, a plurality of instrumentation devices 300, 400, 410, and 420, and a synchronization trigger distribution device 200 to a quantum device 500 that executes a quantum operation. The host PC 100 has a system setting function 1001 for setting and managing the entire system. The plurality of instrumentation devices 300, 400, 410, and 420 each execute at least a part of quantum operations in a control sequence of quantum operations. The synchronization trigger distribution device 200 outputs unique synchronization signals to the instrumentation devices 300, 400, 410, and 420 respectively based on a control sequence table and a response delay time table set by the host PC 100.

In the embodiment, the instrumentation device 300 and the synchronization trigger distribution device 200 have mutually consistent sequence control functions 3001 and 2001, and the instrumentation device 300 serves as a sequence control master device and performs sequence control in cooperation with the synchronization trigger distribution device 200.

The host PC 100 is usually installed in a room temperature environment (for example, 20° C.). On the other hand, a semiconductor chip constituting the quantum device 500 is disposed in an extremely low temperature environment (for example, −272° C.) realized by a mixing chamber whose temperature is the lowest in a cooling device such as a dilution refrigerator, and can operate a quantum dot. The quantum device 500 is similar to a configuration including the quantum bit array disclosed in PTL 3, for example.

Other configurations are generally arranged in a room temperature environment, but among the instrumentation devices 300, 400, 410, and 420, the instrumentation device having the mode of a semiconductor chip may be set to an environment lower in temperature than the room temperature environment in the dilution refrigerator (however, not an extremely low temperature environment in which quantum dots operate). When the cooling capacity of the mixing chamber is sufficiently high, the instrumentation device having the mode of a semiconductor chip and the quantum device 500 may be implemented by the same semiconductor chip, and the entire device may be provided in an extremely low temperature environment.

The host PC 100 is a general information processing apparatus including a microprocessor, a memory, a storage device, an input device, an output device, and the like (not shown). The host PC 100 has the system setting function 1001 for performing device-specific settings for the synchronization trigger distribution device 200 and the instrumentation devices 300, 400, 410, and 420. In the system setting function 1001, it is assumed that in at least some of the instrumentation devices 300, 400, 410, and 420, a system control application is running that performs, as a part of a control sequence, transfer of a quantum dot state read by predetermined measurement processing to the host PC 100 and state monitoring and operation management of the quantum computing system 1.

The system control application interprets a control sequence of a quantum operation specified by a user as an object to be executed, supplies device-specific setting information necessary for the quantum operation to the instrumentation devices 400, 410, 420, and 300 and the synchronization trigger distribution device 200 via communication means 101, 102, 103, 104, and 105, respectively, and performs predetermined communication such as transferring a quantum dot state read by the instrumentation device. Here, the communication means 101, 102, 103, 104, and 105 may be interfaces based on standard communication specifications such as USB (trademark), SPI (trademark), I2C (trademark), RS-232C, GP-IB, PCI, Express (trademark), and Ethernet (trademark), or may have unique specifications based on general-purpose input and output ports.

The synchronization trigger distribution device 200 refers to setting information (a control sequence table and a response delay time table described later) transferred from the host PC 100 via the communication means 105 in advance, updates an internal state of the synchronization trigger distribution device 200 in accordance with contents of an operation request indicated by a master trigger signal 303 that is received from the instrumentation device 300 in accordance with the progress of the control sequence being executed, and independently outputs distribution trigger signals 201-1, 201-2, 201-3, and 201-4 for instructing operation timings to the instrumentation devices 300, 400, 410, and 420, respectively. Details of the configuration and operation will be described later with reference to other drawings.

The instrumentation device 300 includes a bias voltage generation function 4001, a radio-frequency signal generation function 4101, and a computing result read function 4201 which are directly related to control of the quantum operation in the quantum device 500. In addition to the above, the instrumentation device 300 includes an integrated sequence control function 3001 for unifying, with one command string, both of local sequence control that defines operation necessity, operation parameters, operation timings, order, and the like of the built-in functions (in the sense of being closed to the instrumentation device 300), and global sequence control that realizes inter-device synchronization with the instrumentation devices 400, 410, and 420 by transmitting and receiving trigger signals via the synchronization trigger distribution device 200 (in the sense of controlling other devices).

Although not particularly limited, in order to implement the global sequence control, a command set supported by the sequence control function 3001 may include a master trigger output command for controlling output contents to the master trigger signal 303 and a distribution trigger standby command for standby until distribution trigger signal input to the own device via the distribution trigger signal 201-1.

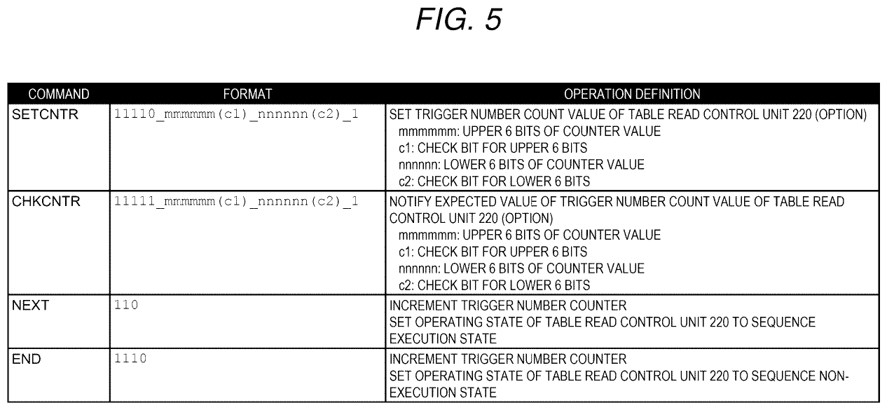

The master trigger output command includes a command for outputting each of four types of master trigger signals shown in FIG. 5 later, and when the instrumentation device 300 executes a command for outputting a master trigger signal, the master trigger signal corresponding to the command is transmitted to the synchronization trigger distribution device 200.

Further, in order to recover from a stack state of control sequence processing, it is preferable to set, in the distribution trigger standby command, a timeout period for cancelling distribution trigger signal input standby based on the execution of the command. The distribution trigger standby command is a command for standby for a trigger signal to return from the synchronization trigger distribution device 200, and can specify a timeout period as an execution parameter. The instrumentation device 300 has a timeout detecting function for detecting that a trigger signal input standby state continues for the specified timeout period or longer after the distribution trigger standby command is executed.

Here, the global sequence control focuses on an event-driven operation. That is, the sequence control master device (the instrumentation device 300 in the embodiment) that manages the overall sequence control of the quantum operation generates the master trigger signal 303 indicating timings of various events such as start and end of the control sequence, change in an operating state (during operation or in idle) of the instrumentation device, change in an output state of the instrumentation devices 400 and 410 that are in charge of control signal output, and measurement processing of the instrumentation device 420 that reads a quantum dot state.

The synchronization trigger distribution device 200 that receives the master trigger signal 303 outputs, only to an instrumentation device to be operated next in response to the event, a trigger signal that enables the operation of the instrumentation device among the distribution trigger signals 201-1, 201-2, 201-3, and 201-4.

Although not particularly limited, the instrumentation device 300 may not have a bias voltage generation function 4001-1, a radio-frequency signal generation function 4101-1, and a computing result read function 4201-1 which are directly related to the control of the quantum operation. In this case, the instrumentation device 300 may be handled as a sequence control dedicated device having only the sequence control function 3001 corresponding to the global sequence control.

Hereinafter, in the control sequence of the quantum operation, a section interposed between two temporally adjacent events is referred to as a subsequence, and it is assumed that the entire control sequence includes one or more subsequences. The sequence control function of the sequence control master device (in the embodiment, the instrumentation device 300) is required to be controlled to explicitly secure a processing time for an instrumentation device other than the own device even in a subsequence in which the own device is not involved in input and output with the quantum device 500. Therefore, it is preferable to define a command capable of describing a “processing standby” subsequence based on a “no-operation” operation capable of specifying an execution time.

The global and local sequence control operations of the instrumentation device 300 are based on the following flow. It is assumed that a command string necessary for control is transferred in advance from the host PC 100 via the communication means 104, and the sequence control function 3001 of the instrumentation device 300 holds a command to be processed next in the command string or holds pointer information specifying a first subsequence, and stands by for execution until the input of the distribution trigger signal 201-1.

Upon receiving the distribution trigger signal 201-1 from the synchronization trigger distribution device 200, the sequence control function 3001 refers to the pointer information and sequentially processes a command string included in the subsequence. Specifically, if a control object of the command is the bias voltage generation function 4001-1, a bias voltage control output signal 301 is generated according to a specified operation parameter, and if the control object is the radio-frequency signal generation function 4101-1, a radio-frequency output signal 302 is generated. If the control object is the computing result read function 4201-1, the local sequence control is implemented by measuring, by a predetermined means, at least one signal state included in a quantum computing unit output signal 521 output from the quantum device 500 and acquiring a quantum dot state.

At the end of the subsequence, the master trigger output command and the distribution trigger standby command are successively arranged, and by executing these commands, the global sequence control, that is, the master trigger signal 303 having a format corresponding to an execution request command of the next subsequence is output, and after the pointer information is updated, a series of processing up to transition to an input standby state of the distribution trigger signal 201-1 is performed.

As a part of the control sequence of the quantum operation, the instrumentation device 400 takes charge of, for example, only a bias voltage generation function 4001-2 for controlling a potential barrier, and generates a bias voltage control output signal 401 at a timing, at which the distribution trigger signal 201-2 is received, based on an operation parameter set in advance via the communication means 101 from the host PC 100. After the operation is completed, standby is executed until the next distribution trigger signal is received.

As a part of the control sequence of the quantum operation, the instrumentation device 410 takes charge of, for example, only a radio-frequency signal generation function 4101-2 for state control of an electron spin, and generates a radio-frequency output signal 411 at a timing, at which the distribution trigger signal 201-3 is received, based on an operation parameter set in advance via the communication means 102 from the host PC 100. After the operation is completed, standby is executed until the next distribution trigger signal is received.

As a part of the control sequence of the quantum operation, the instrumentation device 420 takes charge of, for example, only a computing result read function 4201-2, and measures at least one signal state included in the quantum computing unit output signal 521 by a predetermined means at a timing, at which the distribution trigger signal 201-4 is received, based on an operation parameter set in advance via the communication means 103 from the host PC 100 and acquires the signal state as a quantum dot state. After the operation is completed, standby is executed until the next distribution trigger signal is received.

When the instrumentation device 300 has the bias voltage generation function 4001-1, the radio-frequency signal generation function 4101-1, and the computing result read function 4201-1, and the instrumentation devices 400, 410, and 420 also have the bias voltage generation function 4001-2, the radio-frequency signal generation function 4101-2, and the computing result read function 4201-2, respectively, the function of which instrumentation device is to be used may be selected based on a required specification.

The quantum device 500 includes a quantum computing control unit 510 and a quantum computing unit 520.

The quantum computing control unit 510 is connected to at least one of the bias voltage control output signal 301 and the bias voltage control output signal 401 and temporarily stores at least a part of control information input from the bias voltage control output signal, switches a bias voltage application state of a quantum computing unit control signal 511 including a bias voltage control line, which is a direct control signal for each quantum dot of the quantum computing unit 520, based on the stored control information and a strobe signal included in the bias voltage control output signal, and outputs the bias voltage application state to the quantum computing unit 520.

The quantum computing unit 520 is a quantum dot array in which a plurality of quantum dots whose characteristics are variable by a bias voltage to be applied are connected in a one-dimensional or two-dimensional shape via a transfer gate for controlling the degree of electron transfer or interaction between the quantum dots by the bias voltage. In order to implement a desired quantum operation, the quantum computing unit 520 is connected to at least one of the radio-frequency output signal 302 and the radio-frequency output signal 411 in addition to the quantum computing unit control signal 511. The quantum operation based on a bias voltage of the quantum computing unit control signal 511 and an application state of the radio-frequency output signal is executed, and the quantum computing unit output signal 521 including the quantum dot state is output.

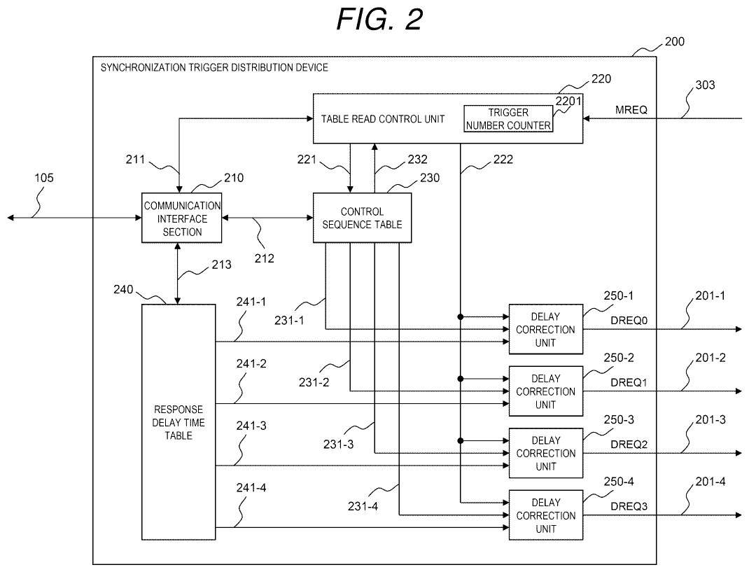

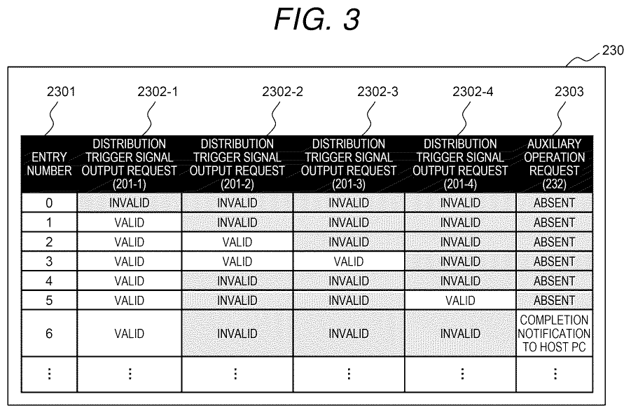

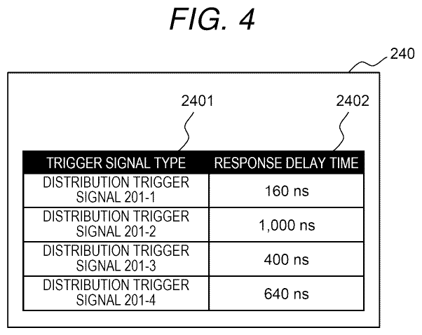

FIG. 2 is a block diagram illustrating a detailed configuration of the synchronization trigger distribution device 200. The synchronization trigger distribution device 200 includes a communication interface section 210, a table read control unit 220, a control sequence table 230, a response delay time table 240, and delay correction units 250-1, 250-2, 250-3, and 250-4 equal in number to the distribution trigger signals 201-1, 201-2, 201-3, and 201-4. Details of the control sequence table 230 and the response delay time table 240 will be described later with reference to FIG. 3 and FIG. 4, respectively.

The communication interface section 210 controls communication with the host PC 100 connected by the communication means 105, and mutually converts various control signals among an internal communication means 211 for controlling access to the table read control unit 220, an internal communication means 212 for controlling access to the control sequence table 230, and an internal communication means 213 for controlling access to the response delay time table 240.

The table read control unit 220 counts the number of times of reception of the master trigger signal 303 (MREQ) by an internal trigger number counter 2201, and specifies a subsequence being executed in the control sequence of the quantum operation based on the count value. In addition, in synchronization with the reception timing of the master trigger signal 303, the table read control unit 220 outputs a read control signal 221 including read entry position information in the control sequence table 230 and a read request to the control sequence table 230, and a timer start request signal 222 for a timer function for time measurement provided in each of the delay correction units 250-1, 250-2, 250-3, and 250-4. The trigger number counter 2201 is designed such that a setting thereof can be updated from the host PC 100 via the communication means 105 and the internal communication means 211. Although not particularly limited, the timer start request signal 222 may include an initial value commonly set for the timer functions of all the delay correction units at the time of requiring timer start.

The table read control unit 220 receives an auxiliary operation control signal 232 from the control sequence table 230 as a response to the read control signal 221, and executes processing based on request contents.

In the control sequence table 230, subsequence setting information from an entry position, which is specified by the read control signal 221, in the table based on the read request from the read control signal 221. In the read subsequence setting information, a timer enable signal 231-1 indicating “enabled or disabled” of the timer function of the delay correction unit 250-1 that corrects an output timing of the distribution trigger signal 201-1 (DREQ0) is output to the delay correction unit 250-1, a timer enable signal 231-2 indicating “enabled or disabled” of the timer function of the delay correction unit 250-2 that corrects an output timing of the distribution trigger signal 201-2 (DREQ1) is output to the delay correction unit 250-2, a timer enable signal 231-3 indicating “enabled or disabled” of the timer function of the delay correction unit 250-3 that corrects an output timing of the distribution trigger signal 201-3 (DREQ2) is output to the delay correction unit 250-3, a timer enable signal 231-4 indicating “enabled or disabled” of the timer function of the delay correction unit 250-4 that corrects an output timing of the distribution trigger signal 201-4 (DREQ3) is output to the delay correction unit 250-4, and the auxiliary operation control signal 232 indicating processing to be executed by the table read control unit 220 is output to the table read control unit 220 in synchronization with the reception timing of the master trigger signal 303.

In the control sequence table 230, it is assumed that setting information necessary for a control sequence of a quantum operation desired to be implemented is set before the start of execution of the control sequence from the host PC 100 via the communication means 105 and the internal communication means 212. Further, it is assumed that the system control application operating on the host PC 100 is responsible for guaranteeing that there is no inconsistency with the sequence control setting information on the instrumentation device 300 side.

The response delay time table 240 holds information on a response delay time of the instrumentation devices 300, 400, 410, and 420 measured in advance, that is, information on a time elapsed from when a device controlling the instrumentation device issues a predetermined operation request to when the requested operation is actually started on the instrumentation device side, and outputs the information as delay correction values 241-1, 241-2, 241-3, and 241-4 to the delay correction units 250-1, 250-2, 250-3, and 250-4, respectively.

In the response delay time table 240, it is assumed that the response delay time of each instrumentation device is set before the start of the execution of the control sequence from the host PC 100 via the communication means 105 and the internal communication means 213.

The response delay times of the instrumentation devices 300, 400, 410, and 420 are preferably measured in a state where the entire system including connections between the devices is mounted. As an example of the measurement method, each instrumentation device may be set to operate so that the control output signal of the instrumentation device changes stepwise, such as on or off, asserted or negated, high level or low level, in response to the input of the distribution trigger signal, and the subsequence may be switched in a state in which the response delay time of all instrumentation devices is designated as zero in the response delay time table 240. By measuring the elapse of time until a change point in the output state of each instrumentation device based on a timing of a subsequence switching request by the master trigger signal 303, the response delay time of each instrumentation device can be collectively acquired. The response delay time in this case corresponds to a delay time starting from the distribution trigger signal. The above procedure may be manually executed, or may be automatically executed as a part of the functions of the system control application operating on the host PC 100.

The delay correction unit 250-1 for correcting the output timing of the distribution trigger signal 201-1 (DREQ0) has a timer function including a time measurement counter. When the timer enable signal 231-1 is enabled and the timer start request signal 222 indicates that the start request is valid, the time measurement counter continuously performs a decrement operation based on a clock signal input (not shown) with a predetermined value such as an initial value included in the timer start request signal 222 as a count start value. When it is detected that a time indicated by the count value of the time measurement counter and a time indicated by the delay correction value 241-1 coincide with each other, that is, when it is detected that the correction of the response delay time is completed, a pulse signal having a fixed assertion time width is output as the distribution trigger signal 201-1 (DREQ0) to the instrumentation device 300, and the decrement operation is stopped.

The delay correction unit 250-2 for correcting the output timing of the distribution trigger signal 201-2 (DREQ1) has a timer function including a time measurement counter. When the timer enable signal 231-2 is enabled and the timer start request signal 222 indicates that the start request is valid, the time measurement counter continuously performs a decrement operation based on a clock signal input (not shown) with a predetermined value such as an initial value included in the timer start request signal 222 as a count start value. When it is detected that a time indicated by the count value of the time measurement counter and a time indicated by the delay correction value 241-2 coincide with each other, that is, when it is detected that the correction of the response delay time is completed, a pulse signal having a fixed assertion time width is output as the distribution trigger signal 201-2 (DREQ1) to the instrumentation device 400, and the decrement operation is stopped.

The delay correction unit 250-3 for correcting the output timing of the distribution trigger signal 201-3 (DREQ2) has a timer function including a time measurement counter. When the timer enable signal 231-3 is enabled and the timer start request signal 222 indicates that the start request is valid, the time measurement counter continuously performs a decrement operation based on a clock signal input (not shown) with a predetermined value such as an initial value included in the timer start request signal 222 as a count start value. When it is detected that a time indicated by the count value of the time measurement counter and a time indicated by the delay correction value 241-3 coincide with each other, that is, when it is detected that the correction of the response delay time is completed, a pulse signal having a fixed assertion time width is output as the distribution trigger signal 201-3 (DREQ2) to the instrumentation device 410, and the decrement operation is stopped.

The delay correction unit 250-4 for correcting the output timing of the distribution trigger signal 201-4 (DREQ3) has a timer function including a time measurement counter. When the timer enable signal 231-4 is enabled and the timer start request signal 222 indicates that the start request is valid, the time measurement counter continuously performs a decrement operation based on a clock signal input (not shown) with a predetermined value such as an initial value included in the timer start request signal 222 as a count start value. When it is detected that a time indicated by the count value of the time measurement counter and a time indicated by the delay correction value 241-4 coincide with each other, that is, when it is detected that the correction of the response delay time is completed, a pulse signal having a fixed assertion time width is output as the distribution trigger the signal 201-4 (DREQ3) to instrumentation device 420, and the decrement operation is stopped.

Here, for example, the time measurement counters in the delay correction units 250-1, 250-2, 250-3, and 250-4 start the decrement operation from a common count start value, and stop the decrement operation independently at a time point when the correction of the response delay time is completed. By changing a stop condition of the decrement operation to a count value of zero, the operation of all the time measurement counters becomes common, so that the plurality of time measurement counters can be integrated into one and a hardware scale can be saved.

The count start values set in the time measurement counters in the delay correction units 250-1, 250-2, 250-3, and 250-4 are main factors for determining time overheads associated with the subsequence switching, and the values should be chose with care. Although not particularly limited, any one of the following (1) to (3) may be used.
(1) Fixation to a maximum value allowed as the specification of the quantum computing system: the hardware scale related to the sequence control can be saved, but the computing performance of the system is extremely degraded when a switching time overhead cannot be ignored as compared with a time (coherence time) in which the quantum dot can maintain quantum properties.
(2) According to the response delay time of the instrumentation device having the maximum response delay time among instrumentation devices involved in one or more times of the control operation in the control sequence of the quantum operation desired to be executed: since one count start value can be statically determined in the entire control sequence, it is easy to balance an increase in hardware scale and the switching time overhead.
(3) According to the response delay time of the instrumentation device having the maximum response delay time among one or more instrumentation devices involved in the control operation in a subsequence being executed: the overhead associated with the switching is minimized by changing the count start value for each subsequence, but it requires a means for designating the count start value for each subsequence, for example, extension of the response delay time table 240.

In addition, when determining the count start value in (2) or (3), it is necessary to consider a case where the response delay time of a specific instrumentation device is extremely long compared to those of other instrumentation devices. In this case, an upper limit is set to a value that can be set as the count start value, and with respect to an instrumentation device having a response delay time exceeding the upper limit, a difference response delay time obtained by subtracting the upper limit of the count start value from the response delay time of the instrumentation device may be separately handled. Specifically, the output timing of the distribution trigger signal is advanced by the difference response delay time by inserting an empty subsequence, which has an execution time corresponding to the difference response delay time and is configured to output the distribution trigger signal to the instrumentation device, immediately before the subsequence in which the instrumentation device originally operates.

The empty subsequence may be further divided into two or more subsequences in which the sum of the execution time and the overhead associated with the switching coincides with the difference response delay time. In the empty subsequence, or in a subsequence obtained by dividing the empty subsequence, an operation other than advancing the distribution trigger signal output may be requested to an instrumentation device other than the instrumentation device.

FIG. 3 illustrates an example of settings in the control sequence table 230. The control sequence table includes a plurality of entries. Each entry identified by an entry number 2301 (corresponding to the count value of the trigger number counter 2201) is associated with a specific subsequence.

One entry has distribution trigger signal output request fields 2302-1, 2302-2, 2302-3, and 2302-4 for specifying whether the instrumentation devices 300, 400, 410, and 420 should operate in the subsequence, that is, whether distribution trigger signal output is necessary for a predetermined instrumentation device 300. Further, each entry has an auxiliary operation request field 2303 for specifying auxiliary operation contents to be processed by the table read control unit 220 in parallel with the execution of the subsequence.

When a read request is received from the table read control unit 220 via the read control signal 221, setting information related to the subsequence is read from a specified entry position in the control sequence table 230, contents of the distribution trigger signal output request fields 2302-1, 2302-2, 2302-3, and 2302-4 are output as the timer enable signals 231-1, 231-2, 231-3, and 231-4, respectively, and contents of the auxiliary operation request field 2303 are output as the auxiliary operation control signal 232.

In the control sequence table 230, the distribution trigger signal to be output is specified, and since the distribution trigger signal corresponds to the instrumentation device, it is synonymous with specifying the instrumentation device corresponding to the count value of the trigger number counter 2201 by the control sequence table 230.

FIG. 4 illustrates an example of settings in the response delay time table 240. The response delay time table includes entries the number of which is equal to the number of trigger signal types 2401, that is, the number of the instrumentation devices 300, 400, 410, and 420, and each entry has a response delay time field 2402 for specifying a response delay time measured in advance in relation to the instrumentation devices 300, 400, 410, and 420 to which the distribution trigger signals 201-1, 201-2, 201-3, and 201-4 are connected.

The delay response time is associated with the distribution trigger signal in the response delay time table 240, and since the distribution trigger signal corresponds to the instrumentation device, it is synonymous with specifying the response delay time corresponding to each of the plurality of instrumentation devices by the response delay time table 240.

The response delay time is, for example, an actual measurement value obtained in advance, and reflects at least one of a propagation delay of a transmission medium connecting the plurality of instrumentation devices and a delay based on a communication protocol. As described above, when the wiring between the blocks reaches, for example, several meters by arranging the blocks (for example, the configurations in FIG. 1) of the device in the cooling device, it is necessary to sufficiently consider the influence of the response delay time.

FIG. 5 illustrates an example of definition of a command format of the master trigger signal 303. In order to execute a consistent control sequence of quantum operations in the quantum computing system 1, it is assumed that, in addition to a fact that control information set in advance does not have a defect, the operation of the sequence control function 3001 of the instrumentation device 300 and the operation of the table read control unit 220 of the synchronization trigger distribution device 200 have coincident subsequences recognized as being executed by a request/response protocol via the master trigger signal 303 and the distribution trigger signal 201-1, that is, the sequence control synchronization is established.

For example, even under conditions that the synchronization trigger distribution device 200 is provided in a room temperature environment outside the dilution refrigerator and the instrumentation device 300 is provided in a low temperature environment inside the dilution refrigerator, leading to an increase in the wiring length of the medium responsible for transmission of the trigger signals and a deterioration in an electromagnetic failure level received by the medium, it is desirable to design a protocol capable of securing certain reliability, such as defining a command format which is not a simple single pulse particularly for the request side (master trigger signal) and providing a unit detecting that sequence control synchronization is not established at least.

Four types of master trigger output commands are defined, and an operation outline of each command is as follows. In the sequence control function 3001 of the instrumentation device 300, the master trigger signal 303, which is seamlessly interpreted and processed together with a command for controlling the built-in functions and has a format defined for each command, is output from the instrumentation device 300.

### SETCNTR:

This command requests the table read control unit 220 to update the count value of the trigger number counter 2201, which is associated with the subsequence to be executed next and is corresponding to the entry number 2301 in the control sequence table 230, to a specified value. Normally, before the start of execution of the control sequence, that is, when an operating state of the table read control unit 220 is a sequence non-execution state, this command is executed as a part of preprocessing of the quantum operation in order to specify a first subsequence of the control sequence to be executed. When a response from the synchronization trigger distribution device 200 is necessary or unnecessary after the execution of this command, the setting of the distribution trigger signal output request field 2302-1 of the entry in the control sequence table 230 specified by this command is set to “valid” or “invalid” correspondingly.

The table read control unit 220, which receives the master trigger signal 303 corresponding to this command, updates the count value of the built-in trigger number counter 2201 to the count value notified by this command.

### CHKCNTR:

This command is a command for the instrumentation device 300 to notify the synchronization trigger distribution device 200 of information indicating its own processing that is, information specifying which subsequence is currently being executed, for the purpose of checking whether a synchronization deviation of the processing occurs. The sequence control function of the instrumentation device 300 notifies the table read control unit 220 of the count value of the trigger number counter 2201, which is associated with the subsequence recognized as being executed at the time of execution of the command and is corresponding to the entry number 2301 in the control sequence table 230.

Normally, during execution of the control sequence, that is, when the operating state of the table read control unit 220 is a sequence execution state, this command is inserted into the control sequence non-periodically for the purpose of confirming that there is no synchronization deviation in the sequence control between the instrumentation device 300 and the synchronization trigger distribution device 200. A setting related to response necessity after the execution of this command is common to that of the SETCNTR command.

The table read control unit 220, which receives the master trigger signal 303 corresponding to this command, confirms whether the count value of the built-in trigger number counter 2201 coincides with the count value notified by this command. If the result is that the count values coincide with each other, the host PC 100 is notified via the internal communication means 211 and the communication means 105 that sequence control synchronization is not established.

### NEXT:

This command requests the table read control unit 220 to increment the setting of the count value of the trigger number counter 2201, which is associated with the subsequence to be executed next and is corresponding to the entry number 2301 in the control sequence table 230, that is, to execute the subsequent subsequence. Although a setting related to response necessity after the execution of this command is common to that of the SETCNTR command, it should be set as “response necessary” in order to maintain a sequence control synchronous state.

The table read control unit 220, which receives the master trigger signal 303 corresponding to this command, increments the count value of the built-in trigger number counter 2201 and sets the operating state to the sequence execution state if the operating state is the sequence non-execution state.

### END:

Similarly to the NEXT command, this command requests the table read control unit 220 to increment the setting of the count value of the trigger number counter 2201. Normally, this command is used for the purpose of requesting execution of postprocessing following the quantum operation. Although a setting related to response necessity after the execution of this command is common to that of the SETCNTR command, it should be set as “response necessary” in order to maintain a sequence control synchronous state.

The table read control unit 220, which receives the master trigger signal 303 corresponding to this command, increments the count value of the built-in trigger number counter 2201 and sets the operating state to the sequence non-execution state if the operating state is the sequence execution state.

The command configuration described above is an example. For example, the NEXT command may be omitted, and a simple timing pulse may be counted by a counter on the receiving side. At this time, commands for instructing count start and count end of the counter are required.

The CHKCNTR command may request not only the instrumentation device 300 but also other instrumentation devices 400, 410, and 420 to notify the synchronization trigger distribution device 200 of information indicating their processing states, that is, information specifying which subsequence is currently being executed.

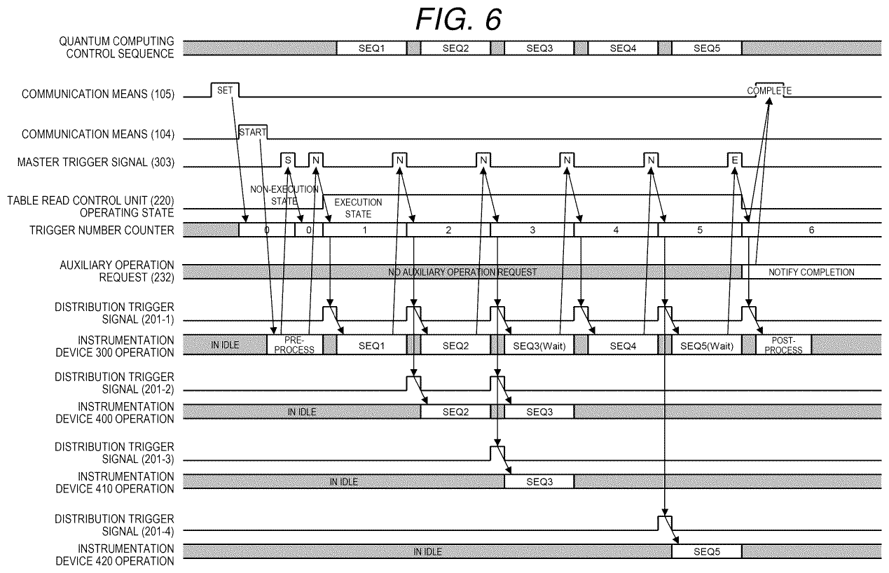

FIG. 6 is a time chart schematically illustrating a flow of processing when a control sequence of the quantum operation based on the settings in the control sequence table 230 illustrated in FIG. 3 is executed in the quantum computing system 1 according to the first embodiment.

Symbols “S”, “N”, and “E” written together with the master trigger signal 303 in the drawing indicate outputs according to the SETCNTR command, the NEXT command, and the END command, respectively. A subsequence denoted by (Wait) in the operation of the instrumentation device 300 indicates a “standby state” in which no direct control output to the quantum device 500 is performed and only the execution time of the subsequence is managed.

The entire control sequence includes seven subsequences indicated by “preprocess” (trigger number counter=0), SEQ1 (trigger number counter=1), SEQ2 (trigger number counter=2), SEQ3 (trigger number counter=3), SEQ4 (trigger number counter=4), SEQ5 (trigger number counter=5), and “post-process” (trigger number counter=6). It is assumed that, prior to the start of execution of the control sequence, the contents of the control sequence table 230 and the response delay time table 240 are appropriately initialized by the system control application running on the host PC 100 via the internal communication means 212 and 213, respectively.

When the initial setting is completed, the host PC 100 sets the trigger number counter 2201 in the table read control unit 220 to zero via the communication means 105 and the internal communication means 211 (in this example, the processing is not essential).

Subsequently, the host PC 100 instructs, via the communication means 104, the sequence control function 3001 in the instrumentation device 300 to start execution from a first subsequence of the control sequence, that is, a preprocessing subsequence. The sequence control function 3001 in the instrumentation device 300, which receives the instruction, executes the SETCNTR command as first processing in the preprocessing subsequence (sets so as not to wait for a response by the distribution trigger signal 201-1), and requests to update the trigger number counter 2201 in the table read control unit 220 to zero via the master trigger signal 303. Further, at the end of the preprocessing subsequence, the NEXT command is executed as second processing (setting is made so as to wait for a response by the distribution trigger signal 201-1), execution of a subsequent SEQ1 subsequence is requested via the master trigger signal 303, and a response from the synchronization trigger distribution device 200 is waited for according to the distribution trigger standby command (not shown).

The table read control unit 220, which receives the request to execute the next subsequence from the master trigger signal 303, shifts the operating state to the sequence execution state and performs increment in the trigger number counter 2201. Further, the control sequence table 230 is requested to read setting information for the SEQ1 subsequence. When the timer enable signal 231-1 indicating “enabled or disabled” of the timer function in the SEQ1 subsequence read from the control sequence table 230 indicates “enabled”, the delay correction unit 250-1 is requested, through the timer start request signal 222, to perform delay correction processing necessary for the distribution trigger signal output by referring to the delay correction value 241-1 related to the instrumentation device 300 output from the response delay time table 240.

The delay correction unit 250-1 which receives the request outputs the distribution trigger signal 201-1, whose output timing is corrected based on the response delay time of the instrumentation device 300, to the instrumentation device 300, whereby the instrumentation device 300 starts execution of the SEQ1 subsequence. At the end of the SEQ1 subsequence, the NEXT command is executed again (setting is made so as to wait for a response by the distribution trigger signal 201-1), execution of a subsequent SEQ2 subsequence is requested, and a response from the synchronization trigger distribution device 200 is waited for according to the trigger standby command (not shown).

By the above procedure, switching between execution target subsequences in cooperation between the synchronization trigger distribution device 200 and the instrumentation device 300 is completed. This switching is repeated up to an SEQ5 subsequence. Although operation control of the instrumentation devices 400, 410, and 420 is basically common to that of the instrumentation device 300, the instrumentation devices 400, 410, and 420 are different from the instrumentation device 300 in that the instrumentation devices 400, 410, and 420 execute only preset operations in synchronization with the distribution trigger signals 201-2, 201-3, and 201-4 and do not contribute to the sequence switching control.

The END command is executed at the end of the SEQ5 subsequence (setting is made so as to wait for a response by the distribution trigger signal 201-1), execution of the subsequent post-processing subsequence is requested via the master trigger signal 303, and a response from the synchronization trigger distribution device 200 is waited for according to the distribution trigger standby command (not shown).

The table read control unit 220, which receives the request to execute the next subsequence from the master trigger signal 303, shifts the operating state to the sequence non-execution state and performs increment in the trigger number counter 2201. Further, the control sequence table 230 is requested to read setting information for the post-processing subsequence. When the timer enable signal 231-1 indicating “enabled or disabled” of the timer function in the post-processing subsequence read from the control sequence table 230 indicates “enabled”, the delay correction unit 250-1 is requested, through the timer start request signal 222, to perform delay correction processing necessary for the distribution trigger signal output by referring to the delay correction value 241-1 related to the instrumentation device 300 output from the response delay time table 240.

Based on the request of the auxiliary operation control signal 232, the table read control unit 220 notifies the host PC 100 of the completion of the execution of the control sequence via the communication means 105 in parallel with the switching to the post-processing subsequence.

The delay correction unit 250-1 which receives the request outputs the distribution trigger signal 201-1, whose output timing is corrected based on the response delay time of the instrumentation device 300, to the instrumentation device 300, whereby the instrumentation device 300 starts execution of the post-processing subsequence. After the execution of the post-processing subsequence is completed, an idle state is established until a new operation request is received from the host PC 100.

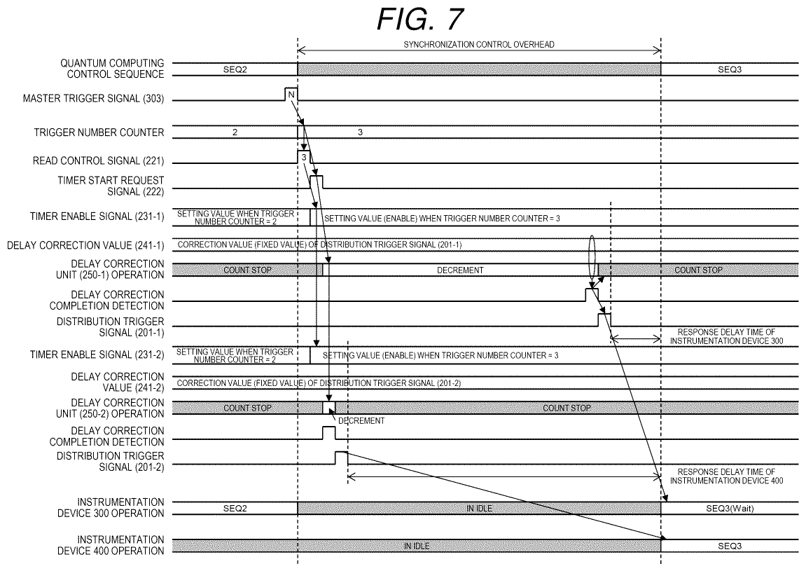

FIG. 7 is a timing chart showing detailed processing in the synchronization trigger distribution device 200 in relation to execution switching from the SEQ2 subsequence to the SEQ3 subsequence, as an example, in the schematic timing chart of the quantum computing sequence described with reference to FIG. 6.

The table read control unit 220, which receives the request to execute the SEQ3 subsequence from the master trigger signal 303, performs increment in the trigger number counter 2201. The control sequence table 230 is requested to read setting information for the SEQ3 subsequence of the entry number 2301 (=3) via the read control signal 221 designating the incremented count value (=3) as the entry position information.

At a timing the setting information reading from the control sequence table 230 is completed, if the timer enable signal 231-1 indicating “enabled or disabled” of the timer function in the SEQ3 subsequence read from the control sequence table 230 indicates “enabled”, the table read control unit 220 requests, through the timer start request signal 222, the delay correction unit 250-1 to perform delay correction processing necessary for the distribution trigger signal output by referring to the delay correction value 241-1 related to the instrumentation device 300 output from the response delay time table 240.

The delay correction unit 250-1, which receives the request, enables the built-in timer function for time measurement, sets a timer initial value included in the timer start request signal 222 as an initial count value in the time measurement counter which is a component implementing the timer function, and then continuously performs a decrement operation of the timer in synchronization with a predetermined clock input signal. When it is detected that a time indicated by the count value of the time measurement counter and a time indicated by the delay correction value 241-1 coincide with each other, that is, when it is detected that the correction of the response delay time is completed, as a trigger signal of the response delay time correction completion, a pulse signal having a fixed assertion time width is output to the instrumentation device 300 as the distribution trigger signal 201-1, and the decrement operation is stopped, and the timer function is disabled. The series of procedures are simultaneously performed for the delay correction units 250-2, 250-3 (not shown), and 250-4 (not shown).

According to the first embodiment described in detail above with reference to the drawings, when the quantum computing system 1 including the plurality of instrumentation devices 300, 400, 410, and 420 executes a control sequence of a quantum operation, the synchronization trigger distribution device 200 having a function of individually correcting a response delay time of each instrumentation device with a subsequence as the control unit is introduced, whereby operations of the instrumentation devices can be synchronized with high time accuracy with a relatively simple configuration, and the requirement related to fidelity of the quantum operation can be satisfied.

Further, regarding the instrumentation device 300 which is a master device of the sequence control in the quantum computing system 1, in addition to a local sequence control command for controlling built-in functions, a command for supporting synchronization between the instrumentation devices and implementing global sequence control is defined, and these commands can be seamlessly handled in one command string, whereby it is possible to implement a sequence control function having high controllability and improve the practicability of the quantum computing system 1.

### Second Embodiment

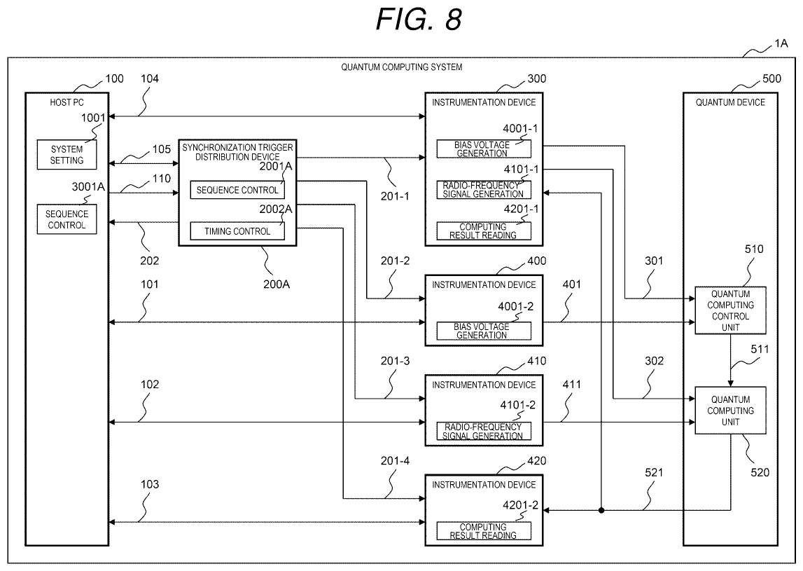

A quantum computing system 1A according to a second embodiment of the invention will be described with reference to FIG. 8. Since the system configuration of the second embodiment is substantially the same as that of the first embodiment, redundant description will be omitted.

The configuration of the quantum computing system 1A is different from the configuration of the quantum computing system 1 (FIG. 1) in the following points. That is, a synchronization trigger distribution device 200A replaces the synchronization trigger distribution device 200, the master trigger signal 303 output by the sequence control function 3001 of the instrumentation device 300 is deleted, and a master trigger signal 110 and a distribution trigger signal 202 are newly added between the synchronization trigger distribution device 200 and the host PC 100. According to the configuration change, the role of the master device in the control sequence of the quantum operation is transferred from the instrumentation device 300 to the host PC 100, and the host PC 100 has a sequence control function 3001A. On the other hand, the instrumentation device 300 executes only the bias voltage generation function 4001-1, the radio-frequency signal generation function 4101-1, and the computing result read function 4201-1, which are preset local sequence control based on the distribution trigger signal 201-1, similarly to the instrumentation devices 400, 410, and 420.

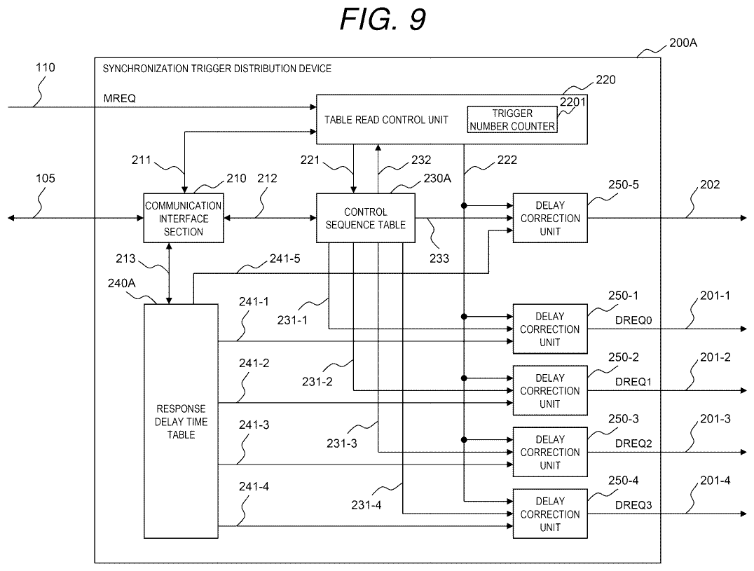

FIG. 9 is a block diagram illustrating a detailed configuration of the synchronization trigger distribution device 200A. Since the configuration of the synchronization trigger distribution device 200A is substantially the same as the configuration of the synchronization trigger distribution device 200, redundant description will be omitted.

The configuration of the synchronization trigger distribution device 200A is different from the configuration of the synchronization trigger distribution device 200 in the following points. That is, the table read control unit 220 receives the master trigger signal 110 instead of the master trigger signal 303, and outputs a trigger signal, in which a response delay time is corrected by a newly added delay correction unit 250-5, as the distribution trigger signal 202 to the host PC 100. The delay correction unit 250-5 has the same function as the delay correction units 250-1, 250-2, 250-3, and 250-4.

Here, the host PC 100 may manage at least an execution time (elapsed time from the start of execution) of a subsequence, and in addition, may perform processing (pre-processing and post-processing) during a period in which each instrumentation device is in an idle state, that is, an operating state of the table read control unit 220 indicates a sequence non-execution state. In any case, the instrumentation devices 300, 400, 410, and 420 perform the control operation for operating the quantum device 500.

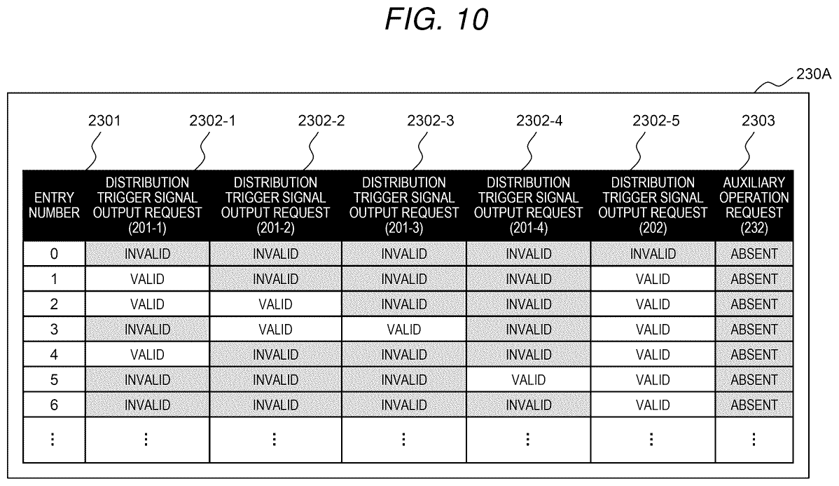

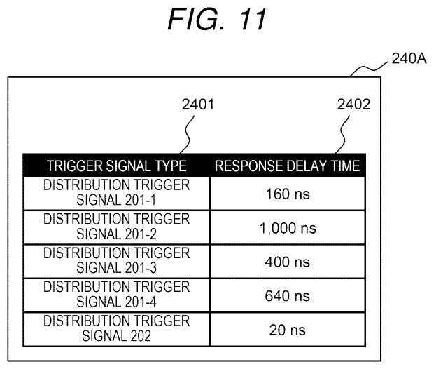

Since the timer enable signal 233 indicating whether the timer function of the delay correction unit 250-5 is enabled or disabled can be output to the delay correction unit 250-5, the control sequence table 230 is replaced with a control sequence table 230A to be described later with reference to FIG. 10, and since a delay correction value 241-5 indicating the response delay time of the host PC 100 can be output to the delay correction unit 250-5, the response delay time table 240 is replaced with a response delay time table 240A to be described later with reference to FIG. 11.

FIG. 10 illustrates an example of settings in the control sequence table 230A. The control sequence table includes a plurality of entries, and each entry identified by the entry number 2301 (corresponding to the count value of the trigger number counter 2201) is associated with a specific subsequence. One entry includes distribution trigger signal output request fields 2302-1, 2302-2, 2302-3, 2302-4, and 2302-5 for specifying whether the instrumentation devices 300, 400, 410, and 420 and the host PC 100 should operate in the subsequence, that is, whether distribution trigger signal output is necessary, and the auxiliary operation request field 2303 for specifying auxiliary operation contents to be processed by the table read control unit 220 in parallel with execution of the subsequence.

When a read request is received from the table read control unit 220 via the read control signal 221, it is requested to read setting information related to the subsequence from a specified entry position in the control sequence table 230A, contents of the distribution trigger signal output request fields 2302-1, 2302-2, 2302-3, 2302-4, and 2302-5 are output as the timer enable signals 231-1, 231-2, 231-3, 231-4, and 233 respectively, and contents of the auxiliary operation request field 2303 are output as the auxiliary operation control signal 232.

FIG. 11 illustrates an example of settings in the response delay time table 240A. The response delay time table includes entries the number of which is equal to the number of trigger signal types 2401, that is, the number of the instrumentation devices 300, 400, 410, 420 and the host PC 100, and each entry has the response delay time field 2402 for specifying a response delay time measured in advance in relation to the instrumentation devices 300, 400, 410, 420 and the host PC 100 to which the distribution trigger signals 201-1, 201-2, 201-3, 201-4, and 202 are connected.

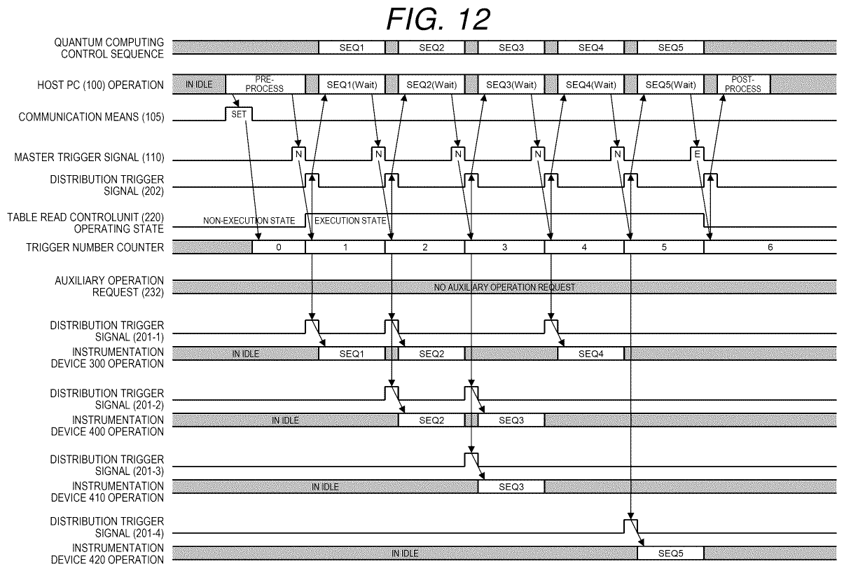

FIG. 12 is a time chart schematically illustrating a flow of processing when a control sequence of the quantum operation based on the settings in the control sequence table 230A illustrated in FIG. 10 is executed in the quantum computing system 1A according to the second embodiment. A main difference from the time chart in the first embodiment is that the host PC 100 performs preprocessing, post-processing, and execution time management of each subsequence via the master trigger signal 110 and the distribution trigger signal 202.

When the initial setting (not shown) of the control sequence table 230A and the response delay time table 240A is completed, the host PC 100 sets the trigger number counter 2201 in the table read control unit 220 to zero via the communication means 105 and the internal communication means 211.

Subsequently, the host PC 100 executes a predetermined preprocessing subsequence, further executes the NEXT command at the end of the preprocessing subsequence (sets to wait for a response by the distribution trigger signal 202), requests execution of the subsequent SEQ1 subsequence via the master trigger signal 110, and waits for a response from the synchronization trigger distribution device 200.

The table read control unit 220, which receives the request to execute the next subsequence from the master trigger signal 110, shifts the operating state to the sequence execution state and performs increment in the trigger number counter 2201. Further, the control sequence table 230A is requested to read setting information for the SEQ1 subsequence. When the timer enable signal 233 indicating “enabled or disabled” of the timer function in the SEQ1 subsequence read from the control sequence table 230A indicates “enabled”, the delay correction unit 250-5 is requested, via the timer start request signal 222, to perform delay correction processing necessary for the distribution trigger signal output by referring to the delay correction value 241-5 related to the host PC 100 output from the response delay time table 240A.

The delay correction unit 250-5 which receives the request outputs the distribution trigger signal 202, whose output timing is corrected based on the response delay time of the host PC 100, to the host PC 100, whereby the host PC 100 starts execution of the processing included in the SEQ1 subsequence and execution time management of the subsequence. At the end of the SEQ1 subsequence processing, the NEXT command is executed again (setting is made so as to wait for a response by the distribution trigger signal 202), execution of the subsequent SEQ2 subsequence is requested, and a response from the synchronization trigger distribution device 200 is waited for again.

By the above procedure, switching between execution target subsequences in cooperation between the synchronization trigger distribution device 200 and the host PC 100 is completed. This switching is repeated up to the SEQ5 subsequence.

The host PC 100 executes the END command at the end of the SEQ5 subsequence processing (sets so as to wait for a response by the distribution trigger signal 202), requests execution of the subsequent post-processing subsequence via the master trigger signal 110, and waits for a response from the synchronization trigger distribution device 200.

The table read control unit 220, which receives the request to execute the next subsequence from the master trigger signal 110, shifts the operating state to the sequence non-execution state and performs increment in the trigger number counter 2201. Further, the control sequence table 230A is requested to read setting information for the post-processing subsequence. When the timer enable signal 233 indicating “enabled or disabled” of the timer function in the post-processing subsequence read from the control sequence table 230A indicates “enabled”, the delay correction unit 250-5 is requested, via the timer start request signal 222, to perform delay correction processing necessary for the distribution trigger signal output by referring to the delay correction value 241-5 related to the host PC 100 output from the response delay time table 240A.

The delay correction unit 250-5 which receives the request outputs the distribution trigger signal 202, whose output timing is corrected based on the response delay time of the host PC 100, to the host PC 100, whereby the host PC 100 starts execution of the post-processing subsequence. The host PC 100 makes a notification (not shown) to the system control application that the control sequence of the quantum operation is completed, for example, as partial processing of the post-processing subsequence, and stands by in an idle state until the next processing request.

In the second embodiment, if time resolution required for the execution time measurement of the subsequence is at a level that can be realized by a timer function of an operating system running on the host PC 100, the execution time management can be transferred to the host PC 100. As a result, a master trigger signal output function is not required on the instrumentation device side, and the instrumentation device can be replaced with a more inexpensive instrumentation device.

### Third Embodiment

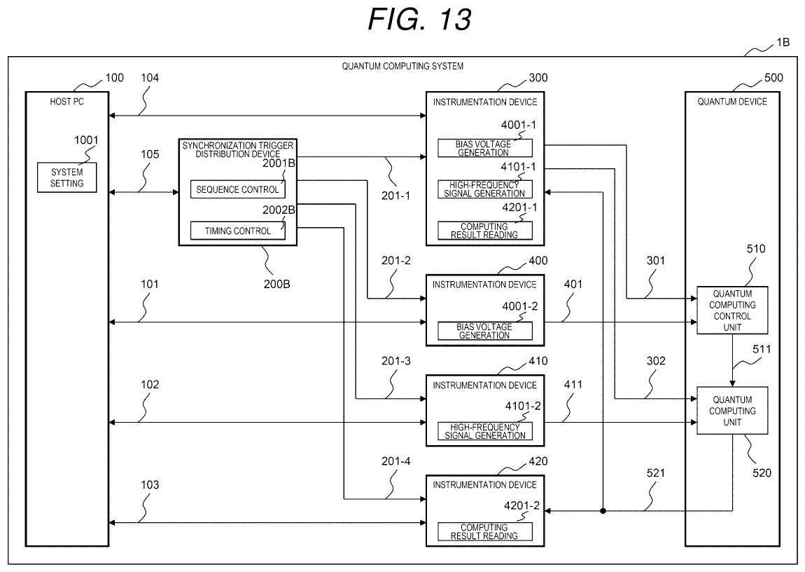

A quantum computing system 1B according to a third embodiment of the invention will be described with reference to FIG. 13. Since the system configuration of the third embodiment is substantially the same as those of the first and second embodiments, redundant description will be omitted.

The configuration of the quantum computing system 1B is different from the configuration of the quantum computing system 1A (FIG. 8) in the following points. That is, in the synchronization trigger distribution device 200, the sequence control function 3001A of the host PC 100 in the second embodiment is replaced by a synchronization trigger distribution device 200B to which an execution time management function is added, and the master trigger signal 110 output from the host PC 100 is deleted. According to the configuration change, the role of the master device in the control sequence of the quantum operation is transferred from the instrumentation device 300 to the synchronization trigger distribution device 200B, and the instrumentation device 300 executes only preset local sequence control based on the distribution trigger signal 201-1 similarly to the instrumentation devices 400, 410, and 420. It is assumed that only the start of sequence control is requested from the host PC 100.

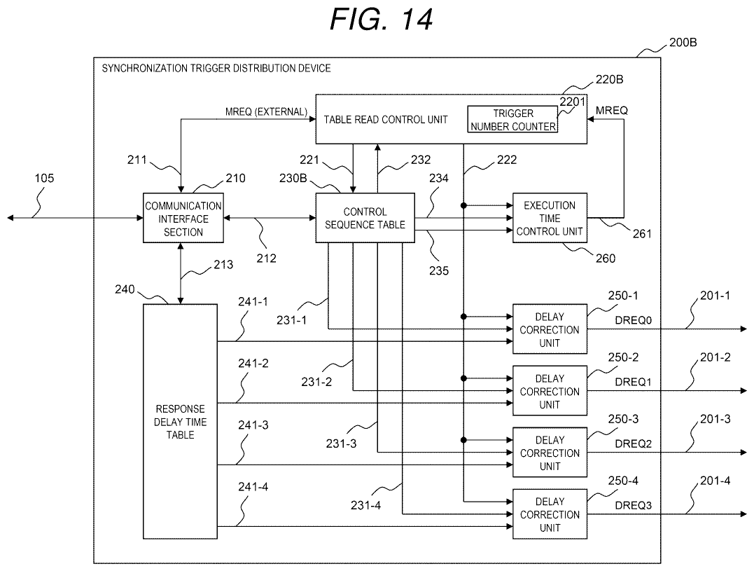

FIG. 14 is a block diagram illustrating a detailed configuration of the synchronization trigger distribution device 200B. Since the configuration of the synchronization trigger distribution device 200B is substantially the same as the configuration of the synchronization trigger distribution device 200, redundant description will be omitted.

The configuration of the synchronization trigger distribution device 200B is different from the configuration of the synchronization trigger distribution device 200 in the following points. That is, the table read control unit 220 is replaced with the table read control unit 220B for which a sequence control start request received from the host PC 100 via the communication means 105 and the internal communication means 211 is corrected so as to be handled as a type of master trigger signal. Further, an execution time control unit 260 is newly added for subsequence execution time management, and the table read control unit 220B receives an internal master trigger signal 261 output from the execution time control unit 260 instead of the master trigger signal 303.

The execution time control unit 260 configured to measure an elapsed time from the beginning of the subsequence has a timer function including a time measurement counter and performs an operation similar to that of the delay correction unit. Specifically, when a timer enable signal 234 indicating whether the timer function is enabled or disabled indicates an enabled state and the timer start request signal 222 indicates a start request, a value corresponding to an execution time indicated by an execution time set value 235 is set as an initial value in the time measurement counter, and a decrement operation is performed based on a clock signal input (not shown). The execution time control unit 260, which detects that the count value of the time measurement counter is zero, stops the decrement operation and outputs a pulse signal having a fixed assertion time width as the internal master trigger signal 261 to the table read control unit 220B. The internal master trigger signal 261 is a signal inside the synchronization trigger distribution device 200B, and there is no distribution trigger signal serving as a response signal to the internal master trigger signal 261 which is a request signal from the execution time control unit 260.

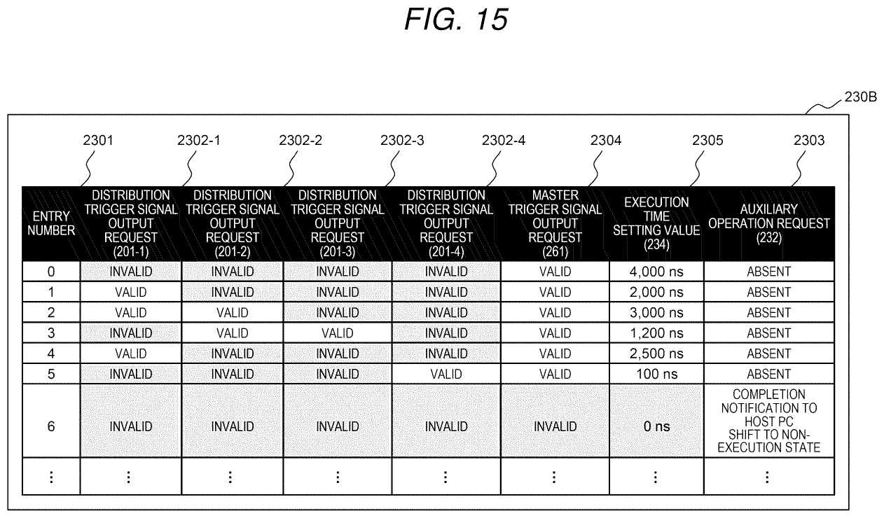

Since the timer enable signal 234 and the execution time set value 235 can be output to the execution time control unit 260, the control sequence table 230 is replaced with a control sequence table 230B described later with reference to FIG. 15. It is not necessary to change the response delay time table 240.

FIG. 15 illustrates an example of settings in the control sequence table 230B. The control sequence table includes a plurality of entries, and each entry identified by the entry number 2301 (corresponding to the count value of the trigger number counter 2201) is associated with a specific subsequence. In addition to the distribution trigger signal output request fields 2302-1, 2302-2, 2302-3, and 2302-4 for specifying whether the instrumentation devices 300, 400, 410, and 420 should operate in the subsequence, that is, whether the distribution trigger signal output is necessary, and the auxiliary operation request field 2303 for specifying auxiliary operation contents to be processed by the table read control unit 220B in parallel with the execution of the subsequence, one entry includes a master trigger signal output request field 2304 for specifying whether to request the execution of the subsequent subsequence after the execution time of the subsequence specified by the entry number 2301 is elapsed, that is, whether the output of the internal master trigger signal 261 is necessary, and an execution time set value field 2305 for specifying the execution time of the subsequence.

When a read request is received from the table read control unit 220B via the read control signal 221, setting information related to the subsequence is read from a specified entry position in the control sequence table 230B, contents of the distribution trigger signal output request fields 2302-1, 2302-2, 2302-3, and 2302-4 are output as the timer enable signals 231-1, 231-2, 231-3, and 231-4, respectively, contents of the auxiliary operation request field 2303 are output as the auxiliary operation control signal 232, contents of the master trigger signal output request field 2304 are output as the timer enable signal 234, and contents of the execution time set value field 2305 are output as the execution time set value 235.

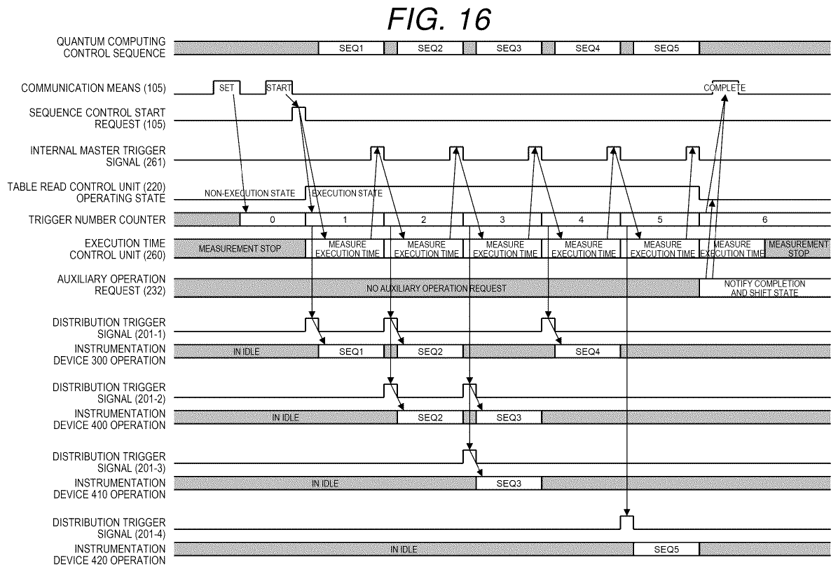

FIG. 16 is a time chart schematically illustrating a flow of processing when a control sequence of the quantum operation based on the settings in the control sequence table 230B illustrated in FIG. 15 is executed in the quantum computing system 1B according to the third embodiment. A main difference from the time chart in the first embodiment is that, by introducing the synchronization trigger distribution device 200B which can generate the internal master trigger signal 261 replacing the master trigger signal 303 output by the instrumentation device 300 and to which an execution time management function is added, the synchronization trigger distribution device 200B serves as a sequence control master device and centrally manages the overall sequence control following the start request. However, when there is processing to be executed as the preprocessing and post-processing subsequences, the processing is executed on the host PC 100 instead of the instrumentation device 300.

When the initial setting (not shown) of the control sequence table 230B and the response delay time table 240 is completed, the host PC 100 sets the trigger number counter 2201 in the table read control unit 220B to zero via the communication means 105 and the internal communication means 211.

Subsequently, as the last processing in the preprocessing subsequence, the host PC 100 requests the table read control unit 220B to start sequence control via the communication means 105 and the internal communication means 211.

The table read control unit 220B, which receives the sequence control start request logically equivalent to the master trigger signal, shifts the operating state to the sequence execution state and performs increment in the trigger number counter. Further, the control sequence table 230B is requested, via the read control signal 221, to read setting information for the SEQ1 subsequence, and the execution time control unit 260 is requested, via the timer start request signal 222, to start measuring the execution time of the SEQ1 subsequence.

When the timer enable signal 234 indicating “enabled or disabled” of the timer function in the SEQ1 subsequence output from the control sequence table 230B indicates “enabled”, the execution time control unit 260 receiving the request starts to measure the execution time, that is, decrement the time measurement counter, with the execution time set value 235 related to the SEQ1 subsequence as an initial value. The execution time control unit 260, which detects that the count value of the time measurement counter is zero, requests the table read control unit 220B to execute the subsequent SEQ2 subsequence via the internal master trigger signal 261.

The table read control unit 220B, which receives the request to execute the SEQ2 subsequence from the internal master trigger signal 261, performs increment in the trigger number counter 2201, requests the control sequence table 230B to read the setting information for the SEQ2 subsequence, and requests the execution time control unit 260 to start measuring the execution time of the SEQ2 subsequence. According to the above procedure, sequence control start processing based on a request of the host PC 100 and switching of first execution target subsequences by the synchronization trigger distribution device 200B alone following the start of the sequence control are completed. The subsequence switching is repeated up to the SEQ5 subsequence, and the host PC 100 is notified of the execution completion of the control sequence through the communication means 105 based on contents of the auxiliary operation control signal 232 in synchronization with switching to an SEQ6 subsequence.

In the third embodiment, although depending on the setting of a clock frequency for updating the time measurement counter provided in the execution time control unit 260, the execution time measurement having time resolution several digits higher than the timer function of a normal operating system can be implemented. In addition, similarly to the second embodiment, since a master trigger signal output function is not required on the instrumentation device side, it is possible to achieve both cost reduction of the instrumentation device and highly accurate execution time management.

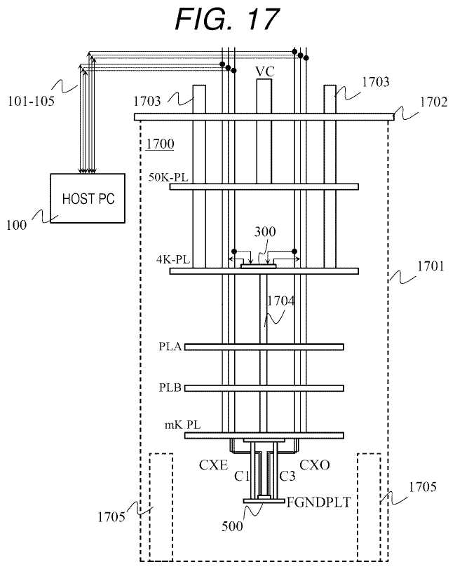

FIG. 17 is a refrigerator mounting diagram of a quantum computer system illustrating a mounting method using the quantum device 500 implemented by a quantum semiconductor, the instrumentation device 300 implemented by an analog chip, the host PC 100, and a dilution refrigerator 1700 according to the first embodiment. Although not shown, the synchronization trigger distribution device 200 and the instrumentation devices 400, 410, and 420 are placed, for example, around the instrumentation device 300 in the dilution refrigerator 1700.

In the dilution refrigerator 1700, an air atmosphere outside the dilution refrigerator 1700 and a vacuum atmosphere inside the dilution refrigerator 1700 are separated by a housing 1701 and a room temperature plate 1702. The degree of vacuum in the housing 1701 of the dilution refrigerator 1700 is controlled by discharging air through a vacuum tube VC using a pump device installed outside the dilution refrigerator 1700. Temperature control in the dilution refrigerator 1700 is implemented by circulating diluted liquid helium in a pulse tube 1703 illustrated in FIG. 17. FIG. 17 illustrates an example in which two pulse tubes 1703 are connected. The diluted liquid helium is obtained by liquefying two isotopes of helium, that is, ³He and ⁴He, respectively, and mixing ³He phase with ⁴He phase for dilution.

In the example of the dilution refrigerator 1700 in FIG. 17, a plurality of metal (mainly oxygen-free copper) plates are provided and stored inside the housing 1701 of the dilution refrigerator 1700. In this example, the metal plates used are 50K-PL (set to −223° C.), 4K-PL (set to −269° C.), PLA, PLB, and mKPL (set to approximately −273° C.). The temperature of the metal plates PLA and PLB is controlled in a range from 4K (−269° C.) to mK (about −273° C.). In the temperature control, a thermal equilibrium state is controlled and maintained by using a temperature control heater (not shown) mounted on each of the metal plates (50K-PL, 4K-PL, PLA, PLB, mKPL) and a temperature controller (not shown) installed outside the dilution refrigerator 1700 for controlling the amount of electric power supplied to the temperature control heater.

In the example in FIG. 17, the diluted liquid helium is circulated from the pulse tube 1703 to a heat sink 1704. Accordingly, the temperature of the metal plate 4K-PL and the metal plate mKPL to which the heat sink 1704 is connected is lowered to an extremely low temperature through the heat sink 1704 in which the diluted liquid helium circulates. Accordingly, the metal plate 4K-PL and the metal plate mKPL can be realized in an atmosphere of an extremely low temperature of 10 mK to 100 mK. The heat sink 1704 may be referred to as a first refrigerating tube, and the pulse tube 1703 may be referred to as a second refrigerating tube. The metal plate mKPL may be referred to as a first metal plate, and the metal plate 4K-PL may be referred to as a second metal plate.

The quantum device 500 is mounted on a first cooling plate FGNDPLT provided below the metal plate mKPL. The cooling plate FGNDPLT is thermally connected to the metal plate mKPL via cooling rods C0 to C3 (the even-numbered cooling rods C0 and C2 are not shown). That is, the heat sink 1704 is a refrigerating tube for cooling the cooling plate FGNDPLT, which is a metal body, using diluted liquid helium. The cooling plate FGNDPLT which is a metal body is thermally connected to the metal plate mKPL via the cooling rods C0 to C3.

The reason why the quantum device 500 is not directly mounted on the metal plate mKPL but is installed below the metal plate mKPL in the example is to cause perform a quantum operation while applying a static magnetic field to the quantum device 500. For the convenience of a space for providing a magnet 1705 for generating a static magnetic field at a lowermost layer of the dilution refrigerator 1700, the quantum device 500 is provided as illustrated in FIG. 17 in the configuration example of the dilution refrigerator 1700 in the example. Control signals (301, 302, 401, 411, and 521) necessary for causing the quantum device 500 to perform a quantum operation are output from at least one of the instrumentation devices 300, 400, 410, and 420, and the control signals are electrically connected to the quantum device 500 via coaxial wires CXE and CXO.

As described above, since the quantum device 500, the instrumentation device 300, and the instrumentation devices 400, 410, and 420 are dispersedly arranged in the dilution refrigerator 1700 having a predetermined volume, the length of the wiring for connecting the quantum device 500, the instrumentation device 300, and the instrumentation devices 400, 410, and 420 is several tens of centimeters to several meters, and it is complicated to adjust the signal delay time.

While embodiments of the invention have been described above, these embodiments have been presented by way of example only, and are not intended to limit the scope of the invention. The novel embodiments can be carried out in various other forms, and various omissions, replacements, and modifications can be made without departing from the gist of the invention. The accompanying claims and their equivalents are intended to cover such forms or modifications as would fall within the scope and gist of the invention. The components described in the embodiments may be implemented by dedicatedly designed hardware such as an application specific integrated circuit (ASIC), or may be implemented by programmable hardware such as a field-programmable gate array (FPGA). Further, at least some of the functions may be performed by software running on the host PC.

According to the above embodiments, since a practical quantum computer can be implemented, the energy consumption can be reduced and the carbon emission can be reduced, contributing to slowing of global warming and development of a sustainable society.

What is claimed is:

1. A quantum computing system comprising:
a quantum device configured to execute a quantum operation;
a plurality of instrumentation devices configured to transmit a control signal for executing the quantum operation to the quantum device; and
a synchronization trigger distribution device configured to transmit a second trigger signal for instructing transmission of the control signal to at least one of the plurality of instrumentation devices based on a first trigger signal indicating a timing, wherein
the synchronization trigger distribution device includes
a control sequence table for specifying a predetermined instrumentation device, to which the second trigger signal is to be output, among the plurality of instrumentation devices based on the first trigger signal, and
a delay time table for specifying a delay time corresponding to each of the plurality of instrumentation devices, and
outputs the second trigger signal to the instrumentation device specified based on the control sequence table, at a timing based on the delay time specified based on the delay time table.

2. The quantum computing system according to claim 1, wherein
the synchronization trigger distribution device includes a table read control unit,
the table read control unit includes a trigger number counter configured to count the first trigger signal, and
the control sequence table specifies a predetermined instrumentation device, to which the second trigger signal is to be output, among the plurality of instrumentation devices based on a count number counted by the trigger number counter.

3. The quantum computing system according to claim 2, wherein
the synchronization trigger distribution device receives a command for requesting the table read control unit to update a count value of the trigger number counter to a specified value.

4. The quantum computing system according to claim 2, wherein
the synchronization trigger distribution device receives information specifying a processing state of the instrumentation device from at least one of the plurality of instrumentation devices.

5. The quantum computing system according to claim 1, wherein
the synchronization trigger distribution device includes a delay correction unit corresponding to each of the plurality of instrumentation devices, and
when the instrumentation device corresponding to the delay correction unit is specified by the control sequence table, the delay correction unit corrects a timing based on the delay time of the instrumentation device corresponding to the delay correction unit, which is specified in the delay time table, and outputs the second trigger signal.

6. The quantum computing system according to claim 1, wherein
the delay time is a delay time starting from the second trigger signal.

7. The quantum computing system according to claim 1, wherein
the delay time includes at least one of a propagation delay of a transmission medium and a delay based on a communication protocol.

8. The quantum computing system according to claim 1, comprising:
a cooling device, wherein
the quantum device is provided at a lowest-temperature portion in the cooling device, and
at least one of the plurality of instrumentation devices and the synchronization trigger distribution device is provided at a portion having a temperature different from the temperature of the portion where the quantum device is provided.

9. The quantum computing system according to claim 8, wherein
the first trigger signal is generated by at least one of the plurality of instrumentation devices.

10. The quantum computing system according to claim 8, wherein
the first trigger signal is specialized in a function related to the first trigger signal and is generated by a device that does not have a function related to the control signal and that is provided at a portion having a temperature different from that of a portion where the quantum device is provided.

11. The quantum computing system according to claim 8, comprising:
a host device provided at a portion closest to room temperature in the system, wherein
the host device generates the first trigger signal.

12. The quantum computing system according to claim 8, wherein
the first trigger signal is generated in the synchronization trigger distribution device.

13. An inter-device synchronization control method for quantum computing,
the method using
a quantum device configured to execute a quantum operation,
a plurality of instrumentation devices configured to transmit a control signal for executing the quantum operation to the quantum device, and
a synchronization trigger distribution device configured to transmit a second trigger signal for instructing transmission of the control signal to at least one of the plurality of instrumentation devices based on a first trigger signal indicating a timing,
the method comprising using the synchronization trigger distribution device to execute:
a first step of specifying a predetermined instrumentation device, to which the second trigger signal is to be input, among the plurality of instrumentation devices based on the first trigger signal;
a second step of specifying a delay time corresponding to each of the plurality of instrumentation devices; and
a third step of outputting the second trigger signal to the instrumentation device specified based on the first step, at a timing based on the delay time specified based on the second step.

14. The inter-device synchronization control method for quantum computing according to claim 13, wherein
in the first step,
the first trigger signal is counted, and
a predetermined instrumentation device, to which the second trigger signal is to be output, is specified from among the plurality of instrumentation devices in accordance with a count value of the first trigger signal.

15. The inter-device synchronization control method for quantum computing according to claim 13, wherein
the quantum device, the instrumentation device, and the synchronization trigger distribution device are provided in a cooling device, and
the first trigger signal is generated by at least one of the instrumentation devices, at least one of the synchronization trigger distribution device, at least one of other devices in the cooling device, and at least one of other devices outside the cooling device.
